(19) United States
(12) Patent Application Publication
(10) Pub. No.: US 2016/0254520 A1
(43) Pub. Date: Sep. 1, 2016

(54) LITHIUM ION SECONDARY BATTERY

(71) Applicant: KABUSHIKI KAISHA TOYOTA JIDOSHOKKI, Kariya-shi, Aichi (JP)

(72) Inventors: Motoaki OKUDA, Kariya-shi (JP); Atsushi MINAGATA, Kariya-shi (JP); Takayuki HIROSE, Kariya-shi (JP)

(73) Assignee: KABUSHIKI KAISHA TOYOTA JIDOSHOKKI, Kariya-shi, Aichi (JP)

(21) Appl. No.: 15/030,241

(22) PCT Filed: Aug. 13, 2014
(86) PCT No.: PCT/JP2014/071399

§ 371 Date: Apr. 18, 2016

(30) Foreign Application Priority Data
Oct. 31, 2013 (JP) 2013-226337

(51) Int. Cl. H01M 2/34; H01M 10/0567; H01M 10/0569; H01M 4/485; H01M 4/587; H01M 10/0525; H01M 10/42

(52) U.S. Cl. CPC H01M 2/345; H01M 10/0525; H01M 10/0567; H01M 10/4235; H01M 4/485; H01M 4/587; H01M 10/0569; H01M 2200/20; H01M 2300/0028

(57) ABSTRACT

A lithium ion secondary battery comprising a case; an electrolyte solution encased in the case; an electrode assembly encased in the case and having a positive electrode and a negative electrode; and a current interrupt device encased in the case for interrupting a current to be supplied to the positive electrode or the negative electrode depending on a pressure in the case. The electrolyte solution contains an additive, a decomposition electric potential of the additive is between an electric potential of the positive electrode in a full charge state and a decomposition electric potential of a solvent in the electrolyte solution. The negative electrode has a capacity capable of intercalating 100% or more of lithium ions deintercalated from the positive electrode when the electric potential at the positive electrode is increased from a full charge state to the decomposition electric potential of the additive to overcharge the battery.

### TECHNICAL FIELD

The present invention relates to a lithium ion secondary battery provided with a current interrupt device.

### BACKGROUND ART

In a lithium ion secondary battery, if it becomes an overcharge state while charging to thereby increase an electric potential of the positive electrode to the decomposition electric potential of a solvent in an electrolyte solution, the decomposition reaction of the solvent is caused. The decomposition reaction is an exothermic reaction, which increases a temperature of a lithium ion secondary battery. For preventing such an exothermic reaction, some lithium ion secondary batteries are provided with a current Interrupt device (CID). When a pressure inside the case of a battery is increased to a threshold, the current interrupt device cuts an electrical connection to outside to interrupt a charging current from outside (see, e.g., Patent Literature 1).

### CITATION LIST

### Patent Literature

Patent Literature 1: Japanese Patent Laid-Open No. 2001-15155

### SUMMARY OF INVENTION

### Technical Problem

Further, in the overcharge state, the higher an electric potential of the positive electrode becomes, the more lithium ions are generated by the reaction at the positive electrode. The negative electrode with a sufficient capacity can receive all of the lithium ions generated at the positive electrode for reaction therewith. However, if a capacity of the negative electrode is insufficient for the lithium ions generated at the positive electrode, lithium metal is deposited on the surface of the negative electrode. The deposit of lithium metal deteriorates the thermal stability of a lithium ion secondary battery. Even when the above current interrupt device is activated to interrupt a charging current and forcibly terminates the reaction at the positive electrode, lithium metal is still deposited at the negative electrode if a capacity of the negative electrode is insufficient for the lithium ions, which have already been generated at the positive electrode by then.

Thus, in the field of the present art, a lithium ion secondary battery capable of preventing the lithium deposition in an overcharge state is in demand.

### Solution to Problem

The lithium ion secondary battery according to an embodiment of the present invention comprises a case, an electrolyte solution encased in the case, an electrode assembly encased in the case and having a positive electrode and a negative electrode, and a current interrupt device encased in the case and being for interrupting a current to be supplied to the positive electrode or the negative electrode depending on a pressure in the case. The electrolyte solution of the lithium ion secondary battery contains an additive. The decomposition electric potential of the additive is an electric potential between the electric potential of the positive electrode in a full charge state of the lithium ion secondary battery and the decomposition electric potential of a solvent in the electrolyte solution.

Further, the negative electrode has a capacity capable of intercalating 100% or more of the lithium ions deintercalated from the positive electrode when the electric potential of the positive electrode is increased from a full charge state to the decomposition electric potential of the additive to overcharge the battery.

In a different standpoint, a capacity ratio of the positive electrode capacity to the negative electrode capacity is a capacity ratio capable of receiving at the negative electrode 100% or more of the lithium ions having been generated at the positive electrode until the state in which the battery is overcharged to the decomposition electric potential of the additive is achieved. Note that the both positive electrode capacity and the negative electrode capacity in the capacity ratio can be the capacities at the time of initial charge.

The lithium ion secondary battery encases the electrode assembly and the electrolyte solution in the case, and the current interrupt device is provided in the case. The electrolyte solution contains an additive, which undergoes a decomposition reaction at a predetermined electric potential. The decomposition electric potential of the additive is an electric potential between the electric potential in a full charge state and the decomposition electric potential of the solvent in the electrolyte solution. Consequently, when an electric potential at the positive electrode is higher at the time of charging than the electric potential in a full charge state (overcharge state), the additive undergoes the decomposition reaction and generates a gas when the electric potential reaches the decomposition electric potential of the additive (an electric potential lower than the decomposition electric potential of the solvent in the electrolyte solution). The generated gas increases a pressure inside the case, and consequently the current interrupt device is activated to interrupt a charging current. Accordingly, an electric potential is never increased even in an overcharge state to the electric potential at which the solvent in the electrolyte solution undergoes the decomposition reaction, whereby the decomposition reaction (exothermic reaction) of the solvent in the electrolyte solution can be prevented. At this time, the positive electrode reacts and generates (deintercalates) lithium ions until the state in which the battery is overcharged to the decomposition electric potential of the additive is achieved. However, the negative electrode of the lithium ion secondary battery has a sufficient capacity capable of receiving all the lithium ions generated by the overcharge at the positive electrode. For this reason, the capacity of the negative electrode is never insufficient to the amount of lithium ions generated at the positive electrode and all the lithium ions can be received (intercalated) at the negative electrode whereby a lithium metal is not deposited at the negative electrode. Thus, the lithium ion secondary battery can prevent the lithium deposition in an overcharge state. As a result, the thermal stability is not reduced due to the lithium deposition and the safety of lithium ion secondary battery is improved.

In an embodiment of the lithium ion secondary battery, the negative electrode has a capacity capable of intercalating 100% or more of the lithium ions deintercalated from the positive electrode when an electric potential of the positive electrode is increased from a full charge state to a predetermined electric potential between the decomposition electric potential of the additive and the decomposition electric potential of the solvent in the electrolyte solution to overcharge the battery.

As described above, even in an overcharge state, when an electric potential of the positive electrode reaches the decomposition electric potential of the additive, the additive usually undergoes the decomposition reaction and activates the current interrupt device whereby the electric potential is not increased to the decomposition electric potential of the solvent in the electrolyte solution. However, in some cases, the additive may not normally undergo the decomposition reaction for some reasons even when an electric potential reaches the decomposition electric potential of the additive and fails to activate the current interrupt device. In such a case, the overcharge is continued and allows the electric potential of the positive electrode to increase to the decomposition electric potential of the solvent in the electrolyte solution, whereby the solvent undergoes the decomposition reaction and generates a gas. Due to this phenomenon, a pressure inside the case increases and the current interrupt device is activated to interrupt a charging current. As discussed, in an overcharge state, an electric potential is highly likely to increase to the decomposition electric potential of the additive at which the current interrupt device is typically activated, but also an electric potential is sometimes likely to increase to the decomposition electric potential of the solvent in the electrolyte solution. Thus, the lithium ion secondary battery has the overcharge upper limit to be up to the decomposition electric potential of the solvent in the electrolyte, at which the capacity of the negative electrode is set.

In an embodiment of the lithium ion secondary battery, the negative electrode has a capacity capable of intercalating 100% or more of the lithium ions deintercalated from the positive electrode when an electric potential of the positive electrode is increased from a full charge state to the decomposition electric potential of the solvent in the electrolyte solution to overcharge the battery.

When the current interrupt device is activated at the decomposition electric potential of the solvent in the electrolyte solution, the positive electrode reacts and generates lithium ions until the state in which the battery is overcharged to the decomposition electric potential of the solvent in the electrolyte is achieved. However, the present lithium ion secondary battery is never insufficient in a capacity of the negative electrode to the lithium ions generated at the positive electrode even in the case described above and accordingly lithium metal is not deposited at the negative electrode. Hence, the present lithium ion secondary battery, even in the case where the current interrupt device is not activated at the decomposition electric potential of the additive, can prevent the lithium deposition caused by the overcharge to the decomposition electric potential of the solvent in the electrolyte solution and thus the safety of the lithium ion secondary battery can be improved.

In an embodiment of the lithium ion secondary battery, the negative electrode has a capacity capable of intercalating 100 to 120% of the lithium ions deintercalated from the positive electrode when the electric potential of the positive electrode is increased from a full charge state to the decomposition electric potential of the additive to overcharge the battery. In an embodiment of the lithium ion secondary battery, the negative electrode has a capacity capable of intercalating 100 to 120% of the lithium ions deintercalated from the positive electrode when an electric potential of the positive electrode is increased from a full charge condition to the decomposition electric potential of the solvent in the electrolyte solution to overcharge the battery.

The production of lithium ion secondary battery (particularly, the positive electrode and negative electrode) suffers from production tolerance. Needless to say, capacities of the produced positive electrode and negative electrode have tolerance against design values and the capacity ratio also has tolerance. For the consideration of such a production tolerance, the capacity of the negative electrode is set to be capable of receiving at the negative electrode 100% to 120% of the lithium ions generated at the positive electrode. By setting the upper limit to 120%, the upper limit of the capacity of the negative electrode can be limited related to the capacity of the positive electrode and thus a capacity of the negative electrode does not becomes more than needed. Consequently, the present lithium ion secondary battery can prevent the lithium deposition in the overcharge state, improve the safety, and also inhibit the reduction of energy density per unit volume.

### Advantageous Effects of Invention

According to the present invention, the lithium deposition in the overcharge state can be prevented.

### BRIEF DESCRIPTION OF DRAWINGS

FIG. 1 is a sectional side view schematically showing the lithium ion secondary battery according to the present embodiment.

FIG. 2 is a graph showing the relationship between the electric potential at the time of overcharging and the internal pressure of the case in the lithium ion secondary battery shown in FIG. 1.

### DESCRIPTION OF EMBODIMENTS

Hereinafter, embodiments of the lithium ion secondary battery according to the present invention are described in reference to the drawings. Note that, in the figures, the same or equivalent elements are denoted by the same symbols, and repeated descriptions thereof are omitted.

The present embodiments are applicable to a lithium ion secondary battery provided with a current interrupt device (an electrical storage device of nonaqueous electrolyte secondary battery). The lithium ion secondary battery according to the present embodiment activates the current interrupt device at a predetermined electric potential in an overcharge state and forcibly terminates the charging to prevent the decomposition reaction (exothermic reaction) of the solvent in the electrolyte solution. For this reason, in the present embodiment, the upper limit of working voltage at the current interrupt device is set at the decomposition electric potential or less of the solvent in the electrolyte solution. Further, in the present embodiment, the current interrupt device is activated before the decomposition electric potential of the solvent in the electrolyte solution is reached. For achieving this, the electrolyte solution contains the additive (overcharge protection additive), which has the decomposition electric potential at a predetermined electric potential between the electric potential in a full charge state and the decomposition electric potential of the solvent in the electrolyte solution. Note that, in the lithium ion secondary battery according to the present embodiment, the electric potential in a full charge state (SOC [State Of Charge]=100%) is 4.1 V.

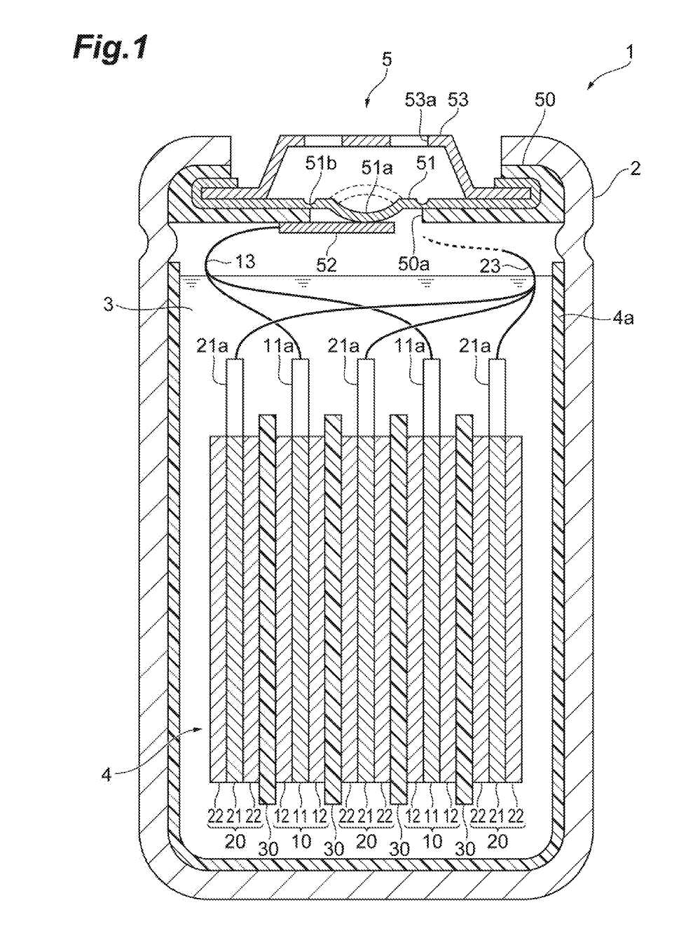

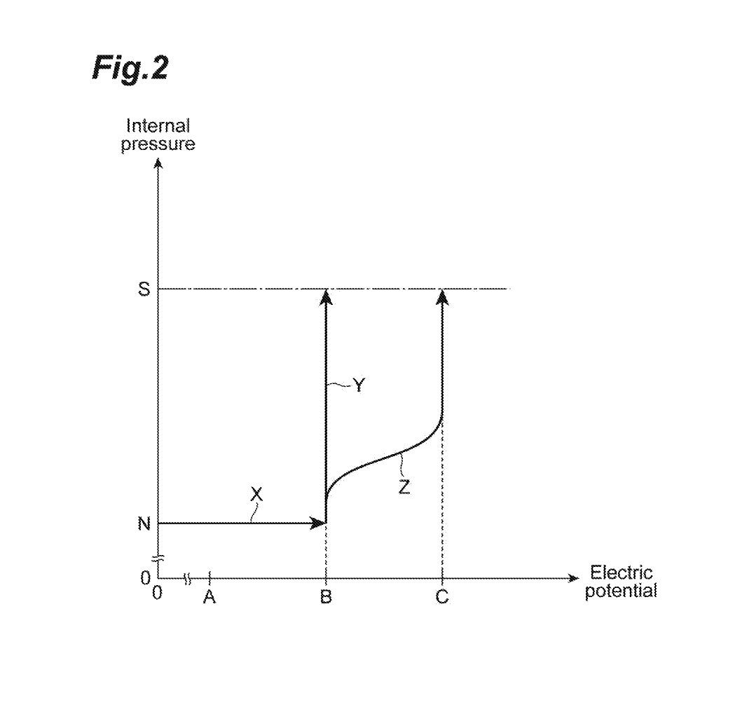

The lithium ion secondary battery 1 according to the present embodiment is described in reference to FIG. 1 and FIG. 2. FIG. 1 is a sectional side view schematically showing the lithium ion secondary battery 1. FIG. 2 is a graph showing the relationship between the electric potential at the time of overcharging and the internal pressure of the case in the lithium ion secondary battery 1.

The lithium ion secondary battery 1 has the capacity of the positive electrode, the capacity of the negative electrode, and the capacity ratio thereof set so that the lithium deposition can be prevented until the current interrupt device is activated in an overcharge state. Particularly, in the lithium ion secondary battery 1, the capacity of the negative electrode is a capacity capable of receiving at the negative electrode 100% or more of the lithium ions generated at the positive electrode when the battery is overcharged to the decomposition electric potential of the additive from the full charge state or the battery is overcharged to the decomposition electric potential of the solvent in the electrolyte.

The lithium ion secondary battery 1 mainly comprises a case 2, an electrolyte solution 3, an electrode assembly 4, and a current interrupt device 5. Note that the case 2, the electrolyte solution 3, the electrode assembly 4, and the current interrupt device 5 to be described in detail below illustrate only an embodiment, and other embodiments may be applied.

The case 2 is a case accommodating the electrolyte solution 3 and the electrode assembly 4. The material and shape of the case 2 are not particularly limited and various known materials such as a resin, metal, or the like, is used to form the case. When the case 2 is a conductive material, the electrode assembly 4 is preferably covered with an insulating sheet 4a in the case 2. The case 2 has an opening at the upper end surface and a current interrupt device 5 is arranged at the upper end portion.

The electrolyte solution 3 is an organic electrolyte solution. The electrolyte solution 3 contains an electrolyte, a solvent for dissolving the electrolyte, and an additive which reacts (decomposes) at a predetermined electric potential in an overcharge state and generates a gas. The electrolyte solution 3 is encased in the case 2 and impregnated into the electrode assembly 4.

The electrolyte is a lithium salt. Examples of the lithium salt include LiBF₄, LiPF₆, LiClO₄, LiAsF₆, LiCF₃SO₃, and LiN(CF₃SO₂)₂. The electrolyte shown herewith is only an example, and other known electrolyte solutions may be applied.

The solvent is a carbonate solvent. Examples of the carbonate solvent include solvents containing all of ethylene carbonate (EC), methyl ethyl carbonate (NEC) and dimethyl carbonate (DMC). The solvents containing EC, MEC and DMC have a decomposition electric potential of 4.6 V and undergo the decomposition reaction when the battery is overcharged to this decomposition electric potential. The decomposition reaction is an exothermic reaction, which generates heat. The decomposition reaction also generates a gas. The solvent shown herewith is only an example, and other known solvents may be applied. The decomposition electric potential varies depending on the solvent used.

The additive is to activate the current interrupt device 5 at the time of overcharging and to prevent the decomposition reaction (exothermic reaction) of the solvent. Consequently, the additive is an additive, which undergoes the decomposition reaction and generates a gas at a predetermined electric potential between the electric potential in a full charge state and the decomposition electric potential of the solvent in the electrolyte solution 3 (particularly, higher than the electric potential in a full charge state and lower than the decomposition electric potential of the solvent). As described above, in the present embodiment, the electric potential at full charge is 4.1 V and the decomposition electric potential of the solvent is 4.6 V. Accordingly, the additive is decomposed at a predetermined electric potential between 4.1 V and 4.6 V. The additives which meet these conditions include cyclohexylbenzene (CHB) and biphenyl (BP). The additives in the examples have a decomposition electric potential of 4.3 V to 4.5 V and undergo the decomposition reaction when the battery is overcharged to these decomposition electric potentials. In the decomposition reaction, a gas is generated. The additive shown herewith is only an example, and other known additives may be used as long as the above condition is met.

The electrode assembly 4 comprises a positive electrode 10, a negative electrode 20, and a separator 30 for insulating the positive electrode 10 from the negative electrode 20. The electrode assembly 4 has a layered structure having a plurality of sheet-like positive electrodes 10 and a plurality of sheet-like negative electrodes 20, and a plurality of sheet-like (or bag-like) separators 30. The electrode assembly 4 is encased in the case 2 and filled with the electrolyte solution 3 in the case 2.

The positive electrode 10 comprises a metal foil 11 and positive electrode active material layers 12, 12 formed on both sides of the metal foil 11. The positive electrode 10 has, on an end portion of the metal foil 11, a tab 11a on which the positive electrode active material layer 12 is not formed. The tab 11a is electrically connected to a lead 13.

The metal foil 11 is, for example, an aluminium foil or an aluminium alloy foil. The positive electrode active material layer 12 contains a positive electrode active material and a binder. The positive electrode active material layer 12 may contain a conductive additive. Examples of the positive electrode active material include complex oxides, metal lithium, and sulfur. The complex oxide contains at least one of manganese, nickel, cobalt and aluminium, and lithium. Examples of the binder include thermoplastic resins such as polyamideimide and polyimide, and polymer resins having an imide bond in the main chain. Examples of the conductive additive include carbon black, graphite, acetylene black, and Ketchen black (registered trademark). The metal foil 11 and the material components contained in the positive electrode active material layer 12 shown herewith are only an example, and other known metal foils and materials contained in the positive electrode active material layer may also be applied.

The negative electrode 20 comprises a metal foil 21 and negative electrode active material layers 22, 22 formed on both sides of the metal foil 21. The negative electrode 20 has, on an end portion of the metal foil 21, a tab 21a on which the negative electrode active material layer 22 is not formed. The tab 21a is electrically connected to a lead 23.

The metal foil 21 is, for example, a copper foil or a copper alloy foil. The negative electrode active material layer 22 contains a negative electrode active material and a binder. The negative electrode active material layer 22 may also contain a conductive additive. Examples of the negative electrode active material include carbons such as graphite, highly oriented graphite, mesocarbon microbeads, hard carbons, and soft carbons; alkali metals such as lithium and sodium; metal compounds; metal oxides such as SiOx (0.5≦x≦1.5); and boron-doped carbon. The binder and conductive additive may be the same binder and conductive additive as described in the positive electrode 10. The metal foil 21 and the material components contained in the negative electrode active material layer 22 shown herewith are only an example, and other known metal foils and materials contained in the negative electrode active material layer may also be applied.

The capacity ratio of capacities of the positive electrode 10 and the negative electrode 20 contained in the electrode assembly 4 is to be descried later in detail. Capacities of the electrodes 10, 20 (e.g., the unit is A·hr) are determined by amounts of the active material layers. 12, 22 (particularly, active materials) of the electrodes 10, 20. The active material layers 12, 22 are formed by applying each of the electrode pastes (obtained by adding a solvent to the materials contained in the above active material layers, kneading and stirring) for the electrodes 10, 20 to the metal foils 11, 21 and drying. Thus, amounts of the active material layers 12, 22 (particularly, active materials) can be controlled by amounts of each electrode paste for the electrodes 10, 20 applied, and capacities of the electrodes 10, 20 are accordingly controlled. Note that, in the present embodiment, the capacity ratio=(capacity of negative electrode 20)/(capacity of positive electrode 10).

The separator 30 insulates the positive electrode 10 from the negative electrode 20 and allows lithium ions to pass through while preventing a short circuit current caused by the contact of both electrodes. Examples of the separator 30 include porous films composed of polyolefin resins such as polyethylene (PE) and polypropylene (PP), woven fabrics and nonwoven fabrics composed of polypropylene, polyethylene terephthalate (PET), methylcellulose or the like. The separator 30 shown herewith is only an example, and other known separators may also be applied.

The current interrupt device 5 cuts an electrical connection from outside when a pressure inside the case 2 reaches the predetermined pressure (threshold) or higher and interrupts a current flowing into the electrode assembly 4. The threshold value of a pressure at which the current interrupt device 5 is activated is a sufficiently higher pressure than the pressure at a normal time in the case 2 and determined in advance. The upper limit value of a voltage at which the current interrupt device 5 is activated is a lower voltage than the decomposition electric potential (4.6 V in the present embodiment) of the solvent in the electrolyte solution 3 and determined in advance. The current interrupt device 5 is structured with a gasket 50, a diaphragm 51, a conductive member 52, and a cover 53. The structure of the current interrupt device 5 shown herewith is only an example, and other known current interrupt devices may also be applied.

The case 2 has the gasket 50 at an opening section on the upper end portion. The gasket 50 has an opening 50a in the center part. The diaphragm 51 is provided on the upper surface of the gasket 50 so that the opening 50a is covered. The diaphragm 51, at the part facing the opening 50a, has a dent 51a projecting to the inner part of the opening 50a. The diaphragm 51 also has a groove 51b on the upper surface thereon surrounding the dent 51a. The conductive member 52 is arranged underside of the gasket 50 so that a part of the member faces the opening 50a. The upper surface of the conductive member 52 is usually in contact with the dent 51a of the diaphragm 51. The cover 53, covering the dent 51a, is provided on the upper side of the diaphragm 51. The diaphragm 51 and the cover 53 are conductive. The cover 53 has an opening 53a. The upper end portion of the case 2 is crimped against the outer surface of the gasket 50 along the circumferential direction so that the gasket 50, the diaphragm 51 and the cover 53 are fixed at the upper end portion of the case 2, which is thus sealed.

The tab 11a and the conductive member 52 at the positive electrode 10 are electrically connected with a lead 13. In other words, the lead 13, the conductive member 52, the diaphragm 51 (dent 51a), and the cover 53 configure a current path, which electrically connects the positive electrode 10 and the outer portion of the case 2. Similarly, a tab 21a at the negative electrode and the unshown conductive member are electrically connected with a lead 23. In other words, the lead 23, the unshown conductive member, the diaphragm 51 (dent 51a), and the cover 53 configure a current path, which electrically connects the negative electrode 20 and the outer portion of the case 2. The diaphragm 51 configures the current interrupt mechanism, which interrupts these current paths depending on a pressure within the case 2. The tabs 11a, 21a at each of the electrodes 10, 20 are connected to the conductive member through the leads 13, 23, but may alternatively be connected by other methods such as immediately connecting the tab to the conductive member by welding.

When a pressure in the case 2 reaches the above threshold of the current interrupt device 5, the dent 51a of the diaphragm 51 is reversed due to the high pressure as indicated by the dotted line in the Figure. This mechanism interrupts the above current path. Accordingly, a state in which the positive electrode 10 and the negative electrode 20 are not electrically connected to the outer portion of the case 2 is achieved.

As described above, the electrolyte solution 3 contains the overcharge protection additive. When an overcharge occurs to the decomposition electric potential of the additive, the additive undergoes the decomposition reaction and generates a gas. The generated gas increases a pressure in the case 2. When such a high pressure reaches the threshold, the current interrupt device 5 is activated (the dent 51a of the diaphragm 51 is reversed) and the electrical connection between the positive electrode 10 and the negative electrode 20 and the outer portion of the case 2 is cut.

Hereinafter, the capacity of the positive electrode 10, the capacity of the negative electrode 20, and the capacity ratio thereof are described in reference to FIG. 2. In FIG. 2, the abscissa indicates the electric potential (particularly, the electric potential of the positive electrode 10) and the ordinate indicates an internal pressure of the case 2, and the figure shows the relationship between the electric potential at the time of overcharging and the internal pressure. Electric potential A is the full charge electric potential, which is 4.1 V in the present embodiment. SOC at this time is 100%. Electric potential B is the decomposition electric potential of the additive in the electrolyte solution 3, and such a potential is 4.3 to 4.5 V in the present embodiment. SOC at this time is 113% in the present embodiment. Electric potential C is the decomposition electric potential of the solvent in the electrolyte solution 3, and such a potential is 4.6 V in the present embodiment. SOC at this time is 129% in the present embodiment. Internal pressure N is the normal pressure of the case 2. Internal pressure S is the threshold pressure at which the current interrupt device 5 is activated.

When the electric potential of the positive electrode 10 exceeds the full-charge electric potential A while charging the lithium ion secondary battery 1, the overcharge is reached. Even with the overcharge state, the internal pressure of the case 2 stays at the normal internal pressure N until the electric potential reaches the decomposition electric potential B of the additive in the electrolyte solution 3 as shown with the solid line X. The current interrupt device 5 is not activated at this internal pressure N.

When the electric potential reaches the decomposition electric potential B of the additive in the electrolyte solution 3, the additive is decomposed and generates a gas to cause an abrupt rise of the internal pressure in the case 2 as shown with the solid line Y. When the internal pressure of the case 2 reaches the threshold S, the current interrupt device 5 is activated, the electrical connection between the positive electrode 10 and the negative electrode 20 and outer portion of the case 2 is cut to interrupt the charging current, whereby the charging is completed. Consequently, the electric potential of the positive electrode 10 is not increased to the electric potential B or higher as long as the additive is normally decomposed and the current interrupt device 5 is thus activated.

However, in some cases, the additive may not normally be decomposed (only decomposed in part or not decomposed in whole) even when the electric potential reaches the decomposition electric potential B of the additive in the electrolyte solution 3. In such a case, the internal pressure of the case 2 is not increased and fails to activate the current interrupt device 5. As a result, as indicated with the solid line Z, the charging continues and the electric potential keeps increasing to the potential electric potential B or higher. Eventually, when the electric potential reaches the decomposition electric potential C of the solvent in the electrolyte solution 3, the solvent is decomposed and generates a gas to cause an abrupt rise of the internal pressure in the case 2 as shown with the solid line Z. When the internal pressure of the case 2 reaches the threshold S, the current interrupt device 5 is activated as in the same manner as described above, whereby the charging is completed. Thus, the electric potential of the positive electrode 10 is not increased to the electric potential C or higher.

When overcharged to the electric potential B, the positive electrode 10 reacts to a capacity equivalent to SOC=113%, generates and releases the lithium ions in the amount in accordance with the reaction (deintercalation). The negative electrode 20 reacts to the lithium ions released from the positive electrode 10 but when fails to receive all the lithium ions (intercalation) (when the amount of lithium ions generated at the positive electrode 10 exceeds the amount of lithium ions the negative electrode 20 is capable of receiving), a lithium metal is deposited on the surface. When the lithium metal is deposited, the thermal stability at the electrode is reduced. To cope with this phenomenon, the capacity of the negative electrode 20 needs to be a capacity capable of receiving 100% or more of the lithium ions generated at the positive electrode 10 when the battery is overcharged to the decomposition electric potential B of the additive in the electrolyte solution 3 from a full charge state.

When the additive is not normally decomposed and the overcharge occurs to the electric potential C, the positive electrode 10 reacts to a capacity equivalent to SOC=129%, generates and releases the lithium ions in the amount in accordance with the reaction. In this case, as in the same as described above, when the negative electrode 20 is not capable of receiving all of lithium ions released from the positive electrode 10, a lithium metal is deposited on the surface. Thus, the capacity of the negative electrode 20, in consideration of the safety when the additive is not normally decomposed, needs to be a capacity capable of receiving 100% or more of the lithium ions generated at the positive electrode 10 when the overcharge occurs from a full charge state to the decomposition electric potential C of the solvent in the electrolyte solution 3. A capacity of the negative electrode 20 becomes larger than the capacity of the negative electrode 20 in the case where the battery is overcharged to the above electric potential B.

As described above, when the capacity of the negative electrode 20 is set to be a capacity capable of receiving 100% or more of the lithium ions generated at the positive electrode 10 in an overcharge state from a full charge state, an excessively large capacity of the negative electrode 20 in consideration of the safety reduces an energy density per unit volume of the lithium ion secondary battery 1. Incidentally, the capacity of the positive electrode 10 contributes to the battery capacity. The larger a capacity of the negative electrode 20 to a capacity of the positive electrode 10, the lower an energy density per unit volume of the lithium ion secondary battery 1. The production of lithium ion secondary battery (particularly, the positive electrode 10 and negative electrode 20) suffers from production tolerance. Needless to say, capacities of the produced positive electrode 10 and negative electrode 20 have tolerance against design values and the capacity ratio also has tolerance. For this reason, the production tolerance of the lithium ion secondary battery 1 (particularly, the positive electrode 10 and negative electrode 20) is considered and the upper limit of the capacity of the negative electrode 20 to the capacity of the positive electrode 10 (i.e., a capacity ratio) is determined. Various tolerances during the production were measured and the measurement results were compiled and analyzed to thus obtain the result of ±10% in the production tolerance. Examples of the various tolerances during the production include the tolerance in the amount of an electrode paste applied, the tolerance in the amounts of the active materials contained in an electrode paste, the tolerance in the amount of the active material layers 12, 22 formed, and the tolerance in the amounts of the active materials contained in the active material layers 12, 22. Thus, considering the obtained production tolerance of ±10%, as a capacity of the negative electrode 20 capable of receiving 100% to 120% of the lithium ions generated at the positive electrode 10 in the overcharge state, the capacity ratio (=capacity of negative electrode 20/capacity of positive electrode 10) are set.

In the case of optimum design (given that the battery is overcharged to the decomposition electric potential B of the additive in the electrolyte solution 3), the capacity ratio is set based on the capacity of the positive electrode 10 being equivalent to SOC=113% (i.e., a capacity ratio of 1.13 is bare minimum) with an addition of the production tolerance of ±10%. In this case, the capacity ratio (=capacity of negative electrode 20/capacity of positive electrode 10)=1.13 to 1.33. 1.23, the median value between the obtained 1.13 and 1.33, is defined to be the design value of capacity ratio and the positive electrode 10 and the negative electrode 20 are produced to have the capacity ratio=1.23. For example, even when the negative electrode 20 produced has a capacity several % less than the design value (alternatively, a capacity of the positive electrode 10 is several % more than the design value), a capacity ratio=1.13 is assured.

For the safer design, (given that the battery is overcharged to the decomposition electric potential C of the solvent in the electrolyte solution 3), the capacity ratio is set based on the capacity of the positive electrode 10 being equivalent to SOC=129% (i.e., a capacity ratio of 1.29 is bare minimum) with an addition of the production tolerance of ±10%. In this case, the capacity ratio (=capacity of negative electrode 20/capacity of positive electrode 10)=1.29 to 1.49. 1.39, the median value between the obtained 1.29 and 1.49, is defined to be the design value of capacity ratio and the positive electrode 10 and the negative electrode 20 are produced to have such a predetermined capacity ratio. For example, even when the negative electrode 20 produced has a capacity several % less than the design value, a capacity ratio=1.29 is assured.

The action of the overcharged lithium ion secondary battery 1 is described in reference to FIG. 1 and FIG. 2. In the description, the positive electrode 10 and the negative electrode 20 are supposedly produced so that the optimum design capacity ratio=1.23 or the safer design capacity ratio=1.39. The description also adopts the case where the additive is normally decomposed at the decomposition electric potential B and the current interrupt device 5 is accordingly activated.

While charging, the underside of the dent 51a of the diaphragm 51 of the current interrupt device 5 contacts the conductive member 52 whereby the positive electrode 10 and the negative electrode 20 and the outer portion of the case 2 are electrically connected to supply a charging current. When the electric potential of the positive electrode 10 exceeds the electric potential A (4.1 V) at full charge (SOC=100%), an overcharge state occurs. Even after overcharged, the charging current is supplied until unless the current interrupt device 5 is activated and the electric potential of the positive electrode 10 keeps rising. At the positive electrode 10, the more the electric potential is increased, the more lithium ions are generated by the reaction. The negative electrode 20 reacts with the generated lithium ions and receives the ions.

When the electric potential of the positive electrode 10 reaches the decomposition electric potential B of the additive in the electrolyte solution 3, the additive is decomposed and generates a gas. The generated gas causes an abrupt rise of the internal pressure of the case 2. Then, when the internal pressure of the case 2 reaches the threshold S, such a high pressure reverses the dent 51a of the diaphragm 51, which is caused to be out of contact with the conductive member 52. Accordingly, the electrical connection between the positive electrode 10 and the negative electrode 20 and the outer portion of the case 2 is cut to interrupt the charging current. Consequently, the charging is terminated and the electric potential of the positive electrode 10 is not increased any more than that. Thus; the overcharge is not continued to the decomposition electric potential C of the solvent in the electrolyte solution 3 and the solvent does not undergo the decomposition reaction (exothermic reaction).

The positive electrode 10 reacts until the state in which the battery is overcharged to the decomposition electric potential B of the additive is achieved and generates lithium ions in accordance with the capacity equivalent to SOC=113%. The negative electrode 20, which has the capacity in accordance with the capacity ratio (design value) 1.23 or 1.39 (the capacity at least in accordance with the capacity ratio 1.13 or 1.29), is capable of reacting to all the lithium ions generated at the positive electrode 10 without causing an insufficient capacity and receiving all the lithium ions. As a result, the negative electrode 20 has no lithium metal deposition.

According to the present lithium ion secondary battery 1, the lithium deposition in an overcharge state (particularly, before the current interrupt device 5 is activated) can be prevented by determining the capacity of the negative electrode to be capable of receiving at the negative electrode 20 100% or more of the lithium ions generated at the positive electrode 10 when the overcharge occurs from the full charge state to the decomposition electric potential of the additive in the electrolyte solution 3. As a result, the thermal stability of the electrode is not deteriorated by the lithium deposition and thus the safety of the lithium ion secondary battery 1 is improved.

According to the present lithium ion secondary battery 1, the lithium deposition in the overcharge state can be prevented by determining the capacity of the negative electrode to be capable of receiving at the negative electrode 20 100% or more of the lithium ions having been generated at the positive electrode 10 until the state in which the battery is overcharged to the decomposition electric potential of the solvent in the electrolyte solution 3 from the full charge state is achieved even when the current interrupt device 5 is not activated at the decomposition electric potential of the additive, whereby the safety of the lithium ion secondary battery 1 can be further improved.

According to the present lithium ion secondary battery 1, the capacity of the negative electrode 20 to the capacity of the positive electrode 10 can be limited, in consideration of the production tolerance, by determining the capacity of the negative electrode to be capable of receiving at the negative electrode 20 100% to 120% of the lithium ions generated at the positive electrode 10 from the full charge state and thus the capacity of the negative electrode 20 does not become unnecessarily large. As a result, the reduction of energy density per unit volume of the lithium ion secondary battery 1 can be inhibited.

According to the present lithium ion secondary battery 1, when the electrolyte solution 3 contains an additive having, as the decomposition electric potential, a predetermined electric potential between the electric potential at a full charge state and the decomposition electric potential of the solvent in the electrolyte solution 3, the current interrupt device 5 can be activated before the battery is overcharged to the decomposition electric potential of the solvent in the electrolyte solution 3, and the occurrence of the overcharge to the decomposition electric potential of the solvent in the electrolyte solution 3 can be prevented. Consequently, the exothermic reaction of the solvent in the electrolyte solution 3 can be prevented and the temperature increase of the lithium ion secondary battery 1 can be inhibited.

Hereinabove, the embodiments according to the present invention are described, but the present invention is not limited to the above embodiments and carried out in various embodiments.

In the present embodiments, for example, given that the battery is overcharged to the decomposition electric potential of the additive in the electrolyte solution and the overcharge is occurred to the decomposition electric potential of the solvent in the electrolyte solution, the capacities of the negative electrode capable of receiving at the negative electrode 100% or more of the lithium ions generated at the positive electrode from the full charge state are illustrated. However, given that the battery is overcharged to a predetermined electric potential between the decomposition electric potential of the additive in the electrolyte solution and the decomposition electric potential of the solvent in the electrolyte solution, the capacity of the negative electrode may be those capable of receiving at the negative electrode 100% or more of the lithium ions generated at the positive electrode from the full charge state. In such a case, the reception upper limit may be set in consideration of the production tolerance.

Further, in the present embodiment, considering a production tolerance of ±10%, the capacity range of the negative electrode capable of receiving at the negative electrode 100% to 120% of the lithium ions generated at the positive electrode from the full charge state is determined to set the design value of the capacity ratio, but the production tolerance may be ±several percent, or ±ten-odd percent.

### REFERENCE SIGNS LIST

1 . . . lithium ion secondary battery, 2 . . . case, 3 . . . electrolyte solution, 4 . . . electrode assembly, 4a . . . insulating sheet, 5 . . . current interrupt device, 10 . . . positive electrode, 11 . . . metal foil, 11a . . . tab, 12 positive electrode active material layer, 13 . . . lead, 20 . . . negative electrode, 21 . . . metal foil, 21a . . . tab, 22 . . . negative electrode active material layer, 23 . . . lead, 30 . . . separator, 50 . . . gasket, 50a . . . opening, 51 . . . diaphragm, 51a . . . dent, 51b . . . groove, 52 . . . conductive member, 53 . . . cover, 53a . . . opening

1. A lithium ion secondary battery comprising: a case; an electrolyte solution encased in the case; an electrode assembly encased in the case and having a positive electrode and a negative electrode; and a current interrupt device encased in the case and being for interrupting a current to be supplied to the positive electrode or the negative electrode depending on a pressure in the case;
wherein
the electrolyte solution contains an additive,
a decomposition electric potential of the additive is an electric potential between an electric potential of the positive electrode in a full charge state of the lithium ion secondary battery and a decomposition electric potential of a solvent in the electrolyte solution, and
the negative electrode has a capacity capable of intercalating 100% or more of lithium ions deintercalated from the positive electrode when the electric potential of the positive electrode is increased from a full charge state to the decomposition electric potential of the additive to overcharge the battery.

2. The lithium ion secondary battery according to claim 1, wherein the negative electrode has a capacity capable of intercalating 100% or more of lithium ions deintercalated from the positive electrode when an electric potential of the positive electrode is increased from a full charge state to a predetermined electric potential between the decomposition electric potential of the additive and the decomposition electric potential of the solvent in the electrolyte solution to overcharge the battery.

3. The lithium ion secondary battery according to claim 2, wherein the negative electrode has a capacity capable of intercalating 100% or more of lithium ions deintercalated from the positive electrode when an electric potential of the positive electrode is increased from a full charge state to the decomposition electric potential of the solvent in the electrolyte solution to overcharge the battery.

4. The lithium ion secondary battery according to claim 1, wherein the negative electrode has a capacity capable of intercalating 100 to 120% of lithium ions deintercalated from the positive electrode when an electric potential of the positive electrode is increased from a full charge state to the decomposition electric potential of the additive to overcharge the battery.

5. The lithium ion secondary battery according to claim 3, wherein the negative electrode has a capacity capable of intercalating 100 to 120% of lithium ions deintercalated from the positive electrode when an electric potential of the positive electrode is increased from a full charge state to the decomposition electric potential of the solvent in the electrolyte solution to overcharge the battery.

6. The lithium ion secondary battery according to claim 1, wherein the solvent contains a carbonate.

7. The lithium ion secondary battery according to claim 1, wherein the solvent contains all of ethylene carbonate, methyl ethyl carbonate and dimethyl carbonate.

8. The lithium ion secondary battery according to claim 1, wherein the decomposition electric potential of the solvent is 4.6 V.

9. The lithium ion secondary battery according to claim 1, wherein the decomposition electric potential of the additive is between 4.1 V and 4.6 V.

10. The lithium ion secondary battery according to claim 1, wherein the decomposition electric potential of the additive is between 4.3 V and 4.5 V.

11. The lithium ion secondary battery according to claim 1, wherein the additive contains cyclohexylbenzene or biphenyl.

12. The lithium ion secondary battery according to claim 1, wherein the positive electrode contains one selected from the group consisting of complex oxides; metal lithium; and sulfur, and
the complex oxides contain at least one of manganese, nickel, cobalt and aluminium; and lithium.

13. The lithium ion secondary battery according to claim 1, wherein the negative electrode contains one selected from the group consisting of carbons; alkali metals; metal compounds; metal oxides; and boron-doped carbon.
